(19) United States
(12) Patent Application Publication
(10) Pub. No.: US 2010/0195731 A1
(43) Pub. Date: Aug. 5, 2010

(54) MOVING IMAGE REPRODUCTION DEVICE AND MOVING IMAGE REPRODUCTION METHOD

(75) Inventor: Koji Imura, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/666,243

(22) PCT Filed: Jul. 2, 2007
(86) PCT No.: PCT/JP2007/063226

§ 371 Date: Dec. 22, 2009

(51) Int. Cl. H04N 7/32; G06F 3/048

(52) U.S. Cl. 375/240.13; 375/E07.243; 715/810

(57) ABSTRACT

A moving image reproduction device which can display a list of contents by an image at an early stage without variation in time even when reproduction is interrupted. A moving image reproduction part (120) decodes coded image data and reproduces the moving image. A monitor (130) displays the reproduced moving image and displays the list of the contents by image. A reproduction position information generation part (140) intra-codes display image data on images to be displayed within a predetermined period including the time of having interrupted the reproduction when the reproduction is interrupted. A list information creation part (150) instructs a reproduction start position image data storage section (113) to output reproduction start position image data to the moving image reproduction part (120), obtains decoded reproduction start position image data from the moving image reproduction part (120), and generates the list of the contents in image.

### TECHNICAL FIELD

The present invention relates in particular to a moving image playback apparatus and moving image playback method that display a list of content.

### BACKGROUND ART

Since the amount of image data is enormous when recording and playing back a moving image, encoding technologies have heretofore existed that are technologies for minimizing the amount of data recorded without degrading the image quality.

Currently, ISO/IEC 14496 Part 2 standardized by an international standardization organization is widely used as a typical technology for reducing the amount of moving image data using encoding technology, and this standard is usually called MPEG-4.

In MPEG-4, both inter-screen encoding (hereinafter referred to as “inter encoding”) and intra-screen encoding (hereinafter referred to as “intra encoding”) are used in order to compress and reduce the amount of data of temporally successive images.

Inter encoding is an encoding method whereby only a difference between an image of a current frame and an image of one frame before in time is calculated, and only the relevant difference information is encoded and recorded.

Intra encoding differs from above-described inter encoding in being an encoding method whereby current-frame data itself, rather than difference information, is encoded and recorded. Generally, the compression efficiency of intra encoding is not as high as that of inter encoding. However, intra encoding is used in first-frame encoding where a preceding frame cannot be referenced, or when compression efficiency is actually lowered by inter encoding due to an excessively large number of differences from the preceding frame, for instance.

Since an inter encoded frame includes only difference information, it cannot be played back unless data of one frame before exists. That is to say, an inter encoding method is an encoding method whereby playback of moving image data is not possible from a midway point.

Therefore, conventionally, in order to enable midway playback when encoding moving image data, an intra encoded frame is generally inserted periodically at fixed time intervals in inter encoded moving image data, and those intervals are arbitrary.

Also, in a moving image playback apparatus that plays back moving image data relating to a plurality of moving image contents, in order to facilitate the selection of moving image content to be played back, a method is adopted whereby an image representing moving image content is displayed (see Patent Document 1, for example). According to Patent Document 1, a playback time for identifying a part for which playback was interrupted is recorded, and moving image content selection by a user is facilitated by displaying images relating to a recorded playback time as a list. Specifically, according to Patent Document 1, only a playback time is recorded, and when playback is interrupted, images to be displayed as a list are generated based on the playback time at which playback was interrupted.

### Patent Document 1: Japanese Patent Application Laid-Open No. 2004-32375

### DISCLOSURE OF INVENTION

### Problems to be Solved by the Invention

However, according to Patent Document 1, an intra encoded frame interval depends on the specifications of a recording apparatus used for recording, and cannot be selected with a playback apparatus. Therefore, if the intra encoded frame interval set by a recording apparatus is extremely long, there is a problem of a long time being taken to generate images to be listed. Also, according to Patent Document 1, variation occurs in a timing at which listed images appear, this being earlier or later according to the intra encoded frame interval timing at which previous playback was interrupted, and there is consequently a problem of possible user confusion and poor user convenience due to the difficulty of predicting the time until listed images will appear.

It is an object of the present invention to provide a moving image playback apparatus and moving image playback method that can display a list of content by means of images promptly and at a uniform timing when playback is interrupted.

### Means for Solving the Problem

A moving image playback apparatus of the present invention employs a configuration having: a moving image playback section that decodes encoded moving image data and plays back a moving image; a storage section that stores image data of an image displayed by the playback within a predetermined time period including a time at which interruption occurred when the playback is interrupted; a list generation section that generates a list of images of each content of the image data stored in the storage section; and a display section that displays a moving image generated by the moving image playback section and also displays the list generated by the list generation section.

A moving image playback method of the present invention has: a step of decoding encoded moving image data and playing back a moving image; a step of storing image data of an image displayed by the playback within a predetermined time period including a time at which interruption occurred when the playback is interrupted; a step of generating a list of images of each content of the image data that has been stored; and a step of displaying the moving image that has been played back and also displaying the list.

### ADVANTAGEOUS EFFECTS OF INVENTION

The present invention enables a list of content to be displayed by means of images promptly and at a uniform timing when playback is interrupted.

### BRIEF DESCRIPTION OF DRAWINGS

FIG. 1 is a block diagram showing the configuration of a moving image playback apparatus according to Embodiment 1 of the present invention;

FIG. 2 is a schematic diagram showing the correspondence relationship between recording and list display of a moving image playback apparatus according to Embodiment 1 of the present invention;

FIG. 3 is a flowchart showing the operation at the time of playback interruption of a moving image playback apparatus according to Embodiment 1 of the present invention;

FIG. 4 is a flowchart showing the operation at the time of playback restart of a moving image playback apparatus according to Embodiment 1 of the present invention; and

FIG. 5 is a block diagram showing the configuration of a moving image playback apparatus according to Embodiment 2 of the present invention.

### BEST MODE FOR CARRYING OUT THE INVENTION

Now, embodiments of the present invention will be described in detail with reference to the accompanying drawings.

### Embodiment 1

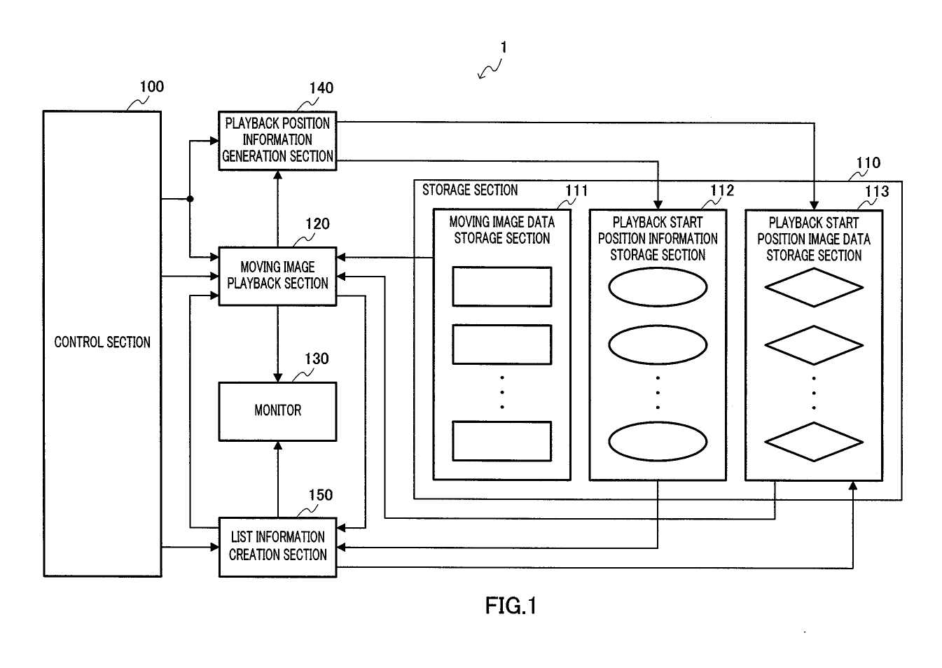

FIG. 1 is a block diagram showing the configuration of moving image playback apparatus 1 according to Embodiment 1 of the present invention.

In FIG. 1, moving image playback apparatus 1 chiefly comprises control section 100, storage section 110, moving image playback section 120, monitor 130, playback position information generation section 140, and list information creation section 150.

Control section 100 performs overall control of moving image playback apparatus 1. Also, control section 100 generates a control signal for starting or interrupting moving image playback apparatus 1 playback operation based on a directive from an operation section (not shown), and outputs this control signal to moving image playback section 120, playback position information generation section 140, and list information creation section 150. Furthermore, control section 100 generates an image selection signal specifying an image when a list is created by list information creation section 150, and outputs this image selection signal to moving image playback section 120. For example, control section 100 generates an image selection signal that selects an image displayed on monitor 130 before a time at which playback was interrupted, an image being displayed on monitor 130 when playback was interrupted, or an image to be displayed on monitor 130 after a time at which playback was interrupted.

Storage section 110 has moving image data storage section 111, playback start position information section 112, and playback start position image data storage section 113. Storage section 110 comprises a hard disk apparatus or the like, for example. Storage section 110 is not limited to a hard disk apparatus, and may also comprise a DVD apparatus or a semiconductor storage apparatus such as flash memory.

Moving image data storage section 111 stores intra encoded moving image data or moving image data for which both intra encoding and inter encoding are used.

Playback start position information storage section 112 stores playback start position information, which is information indicating a playback time from start to interruption of moving image data playback, input from playback position information generation section 140.

Playback start position image data storage section 113 stores playback start position image data, which is display image data, input from playback position information generation section 140.

Moving image playback section 120 reads moving image data stored in moving image data storage section 111 from moving image data storage section 111. Then moving image playback section 120 decodes the read moving image data by means of a method corresponding to intra encoding if the read moving image data has been intra encoded, or by means of a method corresponding to inter encoding if the read moving image data has been inter encoded, and sequentially generates display images, and outputs these display images to monitor 130.

Also, when a control signal for interrupting playback operation is input from control section 100, moving image playback section 120 interrupts playback. Then moving image playback section 120 outputs the playback time period from start to interruption of playback, and display image data on images to be displayed on monitor 130 within a predetermined time period including the time at which playback was interrupted, to playback position information generation section 140. For example, moving image playback section 120 has memory that stores images equivalent to 3 screens of monitor 130, and accumulates decoded images sequentially in the memory. Then, when a playback operation interruption control signal is received from control section 100, moving image playback section 120 selects the oldest image accumulated in the memory in accordance with an image selection signal input from control section 100, and outputs this image to playback position information generation section 140. By this means, moving image playback section 120 outputs an image displayed on monitor 130 before the time at which playback operation was interrupted. Also, when a playback operation interruption control signal is received, moving image playback section 120 selects the newest image accumulated in the memory in accordance with an image selection signal input from control section 100, and outputs this image to playback position information generation section 140. By this means, moving image playback section 120 outputs an image to be displayed on monitor 130 after the time at which playback operation was interrupted. Furthermore, when a playback operation interruption control signal is received, moving image playback section 120 selects an image that was being displayed on monitor 130 when playback was interrupted to be accumulated in memory in accordance with an image selection signal input from control section 100, and outputs this image to playback position information generation section 140.

Also, moving image playback section 120 selects image data encoded by inter-screen encoding or bidirectional predictive encoding (generally called “B frame”) between the nearest image data encoded by means of an intra encoding method within images displayed within a predetermined time period including the time at which playback was interrupted, and outputs this image data to playback position information generation section 140. Furthermore, moving image playback section 120 performs decoding processing of playback start position image data acquired from playback start position image data storage section 113, and outputs this data to list information creation section 150.

Playback position information generation section 140 outputs a playback time period input from moving image playback section 120 to playback start position information storage section 112 as playback start position information. Also, playback position information generation section 140 changes the size of an image of display image data input from moving image playback section 120 to an image size having a number of vertical and horizontal pixels identical to the number of vertical and horizontal pixels when displayed in a list on monitor 130. Furthermore, playback position information generation section 140 performs encoding processing on display image data of an image whose size has been changed. Then playback position information generation section 140 associates display image data that has undergone encoding processing with playback start position information as playback start position image data and outputs this to playback start position image data storage section 113.

List information creation section 150 determines whether or not playback start position information has been stored in playback start position information storage section 112 within storage section 110. If list information creation section 150 determines that playback start position information has been stored, list information creation section 150 gives a directive for output of playback start position image data stored in playback start position image data storage section 113 within storage section 110 to moving image playback section 120, and acquires playback start position image data that has undergone decoding processing from moving image playback section 120. On the other hand, if list information creation section 150 determines that playback start position information has not been stored, list information creation section 150 issues a request to moving image playback section 120 for first-frame display image output, and acquires a display image. Furthermore, list information creation section 150 generates a thumbnail image based on playback start position information acquired from playback start position information storage section 112 within storage section 110 and playback start position image data that has undergone decoding processing acquired from moving image playback section 120 or a display image acquired from moving image playback section 120, and outputs the generated thumbnail image to monitor 130.

Monitor 130 displays a display image played back by moving image playback section 120. Also, monitor 130 displays a thumbnail image input from list information creation section 150.

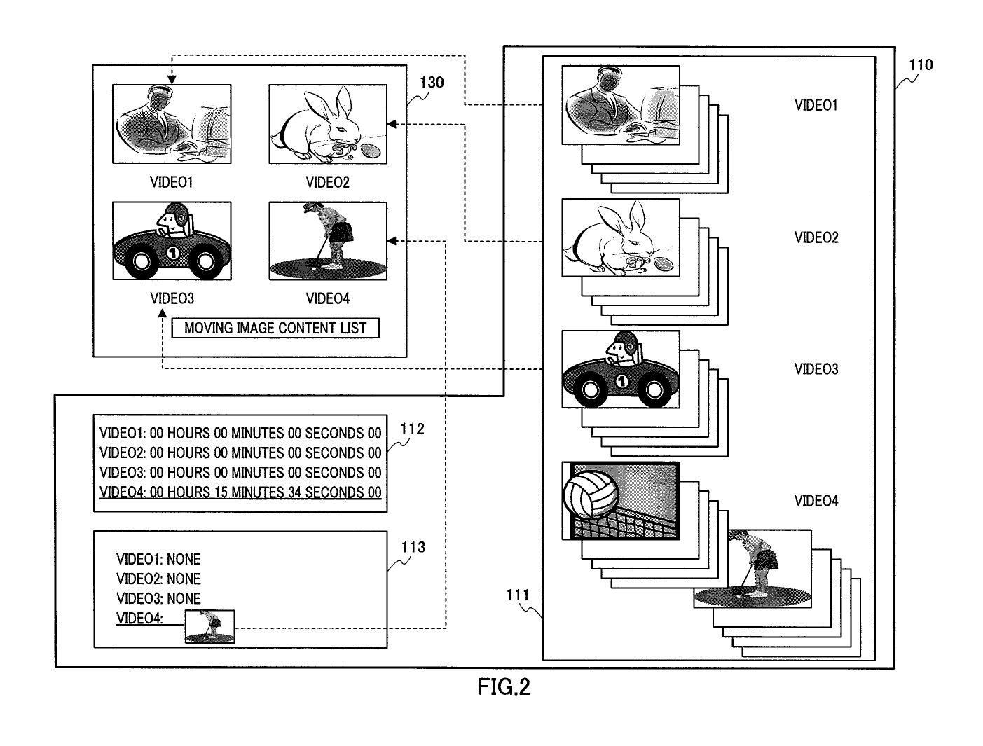

FIG. 2 is a drawing showing schematically the correspondence relationship between storage section 110 storage contents and monitor 130 display contents.

In FIG. 2, moving image data storage section 111 stores, for example, four moving image contents Video1 through Video4. Of the four moving image contents Video1 through Video4, playback is shown as having been completed for Video1 through Video3, while playback is shown as having been interrupted at a golf scene for Video4.

Also, in FIG. 2, playback start position information storage section 112 stores “00 hours 15 minutes 34 seconds 00” as playback start position information for moving image content Video4. That is to say, for moving image content Video4, playback start position information storage section 112 stores the fact that playback was interrupted after Video4 was viewed until 15 minutes and 34 seconds 00 had elapsed from the playback start time—that is, the fact that the playback time period is 15 minutes and 34 seconds 00. Also, for moving image contents Video1 through Video3, playback start position information storage section 112 stores “00 hours 00 minutes 00 seconds 00” as playback start position information. That is to say, for moving image contents Video1 through Video3, playback start position information storage section 112 stores the fact that playback has been completed.

In FIG. 2, playback start position image data storage section 113 stores an moving image content golf scene at which playback was interrupted. That is to say, playback start position image data storage section 113 stores, by means of image data, the fact that when playback is restarted after being interrupted at a golf scene, playback should be started from the golf scene.

In FIG. 2, monitor 130 displays, by means of image data, four moving image contents Video1 through Video4 as a moving image content list, and also displays the golf scene at which playback was interrupted for moving image content Video4 whose playback was interrupted. Monitor 130 displays the initial screens of moving image contents Video1 through Video3 as representative image data of moving image contents Video1 through Video3. Therefore, by being aware of the association between the initial screens and respective moving image contents beforehand, the user can identify each moving image content stored in moving image data storage section 111 by viewing the initial screens displayed on monitor 130.

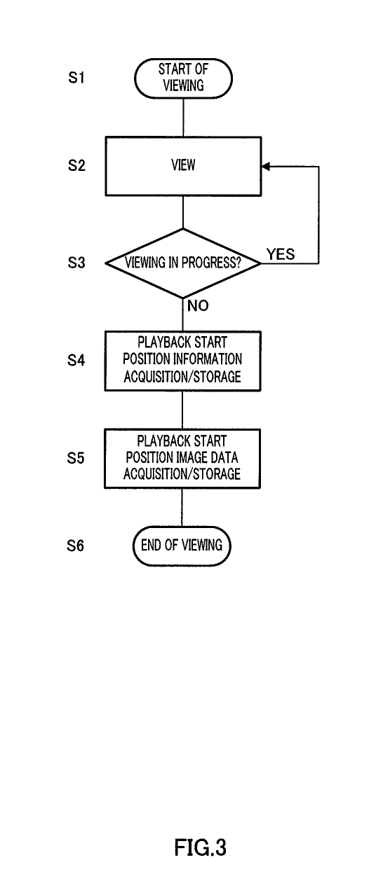

Next, the operation of moving image playback apparatus 1 when playback operation is interrupted will be described using FIG. 3. FIG. 3 is a flowchart showing the operation of moving image playback apparatus 1 when playback operation is interrupted.

First, while the user is viewing, control section 100 gives a directive to moving image playback section 120 for playback processing (S1).

Next, moving image playback section 120 sequentially reads moving image data stored in moving image data storage section 111 of storage section 110, performs decoding processing, and outputs a playback image to monitor 130 (S2), and the user continuously views a playback image on monitor 130 through the display of a playback image by monitor 130 (S3: YES, S2).

Then, when a playback interruption directive is received (S3: NO), control section 100 outputs an interruption directive to playback position information generation section 140 and moving image playback section 120.

Next, moving image playback section 120 outputs the playback time period at the time at which the interruption directive was received and display image data at the time at which the interruption directive was received to playback position information generation section 140. Then playback position information generation section 140 acquires the playback time period input from moving image playback section 120 as playback start position information, and stores this in playback start position information storage section 112 within storage section 110 (S4).

Next, playback position information generation section 140 changes display image data input from moving image playback section 120 to display image data of a size used when performing list information display, performs intra encoding using the same encoding method as for moving image data, and stores the data in playback start position image data storage section 113 within storage section 110 (S5), and moving image playback apparatus 1 terminates viewing processing (S6).

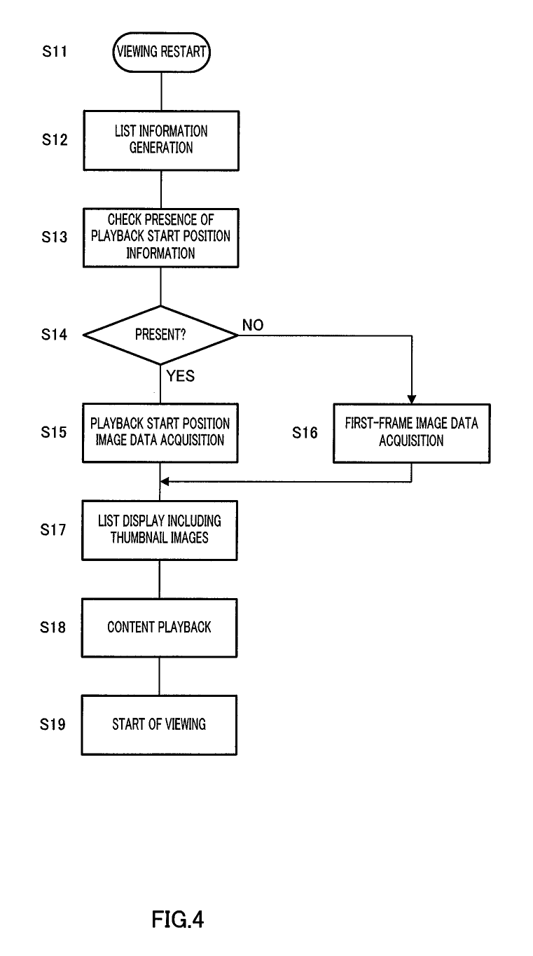

The operation of moving image playback apparatus 1 for moving image content list display and moving image content selection will now be described using FIG. 4. FIG. 4 is a flowchart showing the operation of moving image playback apparatus 1 for moving image content list display and moving image content selection.

When viewing is restarted (S11), control section 100 gives a directive to list information creation section 150 for list information generation (S12).

Next, list information creation section 150 reads playback start position information from playback start position information storage section 112 within storage section 110, and checks for the presence of playback start position information (S13).

Then, if playback start position information has been stored (S14: YES), list information creation section 150 gives a directive for output of playback start position image data stored in playback start position image data storage section 113 to moving image playback section 120, and acquires playback position image data that has undergone decoding processing by moving image playback section 120 (S15).

If playback start position information has not been stored (S14: NO), list information creation section 150 issues a request for output of first-frame playback image data to moving image playback section 120, and moving image playback section 120 acquires first-frame playback image data.

Next, list information creation section 150 outputs a list of moving image data and corresponding thumbnail images to monitor 130 based on playback position image data obtained in step S15 or S16. Then, as shown in the illustration of monitor 130 in FIG. 2, for example, monitor 130 displays a list of moving image contents including three moving image contents Video1 through Video3 for which playback has been completed and moving image content Video4 whose playback has been interrupted (S17).

Next, when the user looks at the moving image content list shown on monitor 130 and selects moving image data he or she wishes to view from among these moving images, control section 100 outputs a directive for playback of the relevant moving image content to moving image playback section 120 (S18), and moving image playback section 120 plays back the relevant moving image content and displays it on monitor 130, and the user resumes viewing of the moving image content he or she wishes to view (S19).

In the above case, it has been stated that a first-frame playback image is decoded and displayed if playback start position information has not been stored, but provision may also be made for a first-frame playback image to be stored beforehand in playback start position image data storage section 113 as playback start position image data, and for playback position image data to be read from playback start position image data storage section 113 when list information generation is performed.

As described above, according to this embodiment a list of content can be displayed by means of images promptly and at a uniform timing when playback is interrupted, and user convenience can be improved. In particular, when storage section 110 stores a large number of moving image contents of large volume, playback start position image data that is easily recognizable by a user is displayed, enabling the user to select desired moving image content and restart playback with certainty. Also, according to this embodiment display image data is intra encoded before being stored, enabling the amount of image data that is stored to be reduced. Furthermore, according to this embodiment, when moving image data stored in moving image data storage section 111 has been intra encoded, display image data is encoded using an encoding method identical to the moving image data encoding method, enabling the encoding method to be made the same for moving image data and playback start position image data stored in storage section 110, and enabling an increase in the processing load when displaying moving image data and playback start position image data as images to be suppressed. Moreover, according to this embodiment a display image is changed to display image data having a number of vertical and horizontal pixels identical to the number of vertical and horizontal pixels when performing list display, enabling the amount of image data that is stored to be further reduced. In addition, according to this embodiment playback start position image data is read after determining whether or not playback start position information is present, enabling the presence of content whose playback was interrupted to be determined easily, and also enabling list creation to be performed easily.

### Embodiment 2

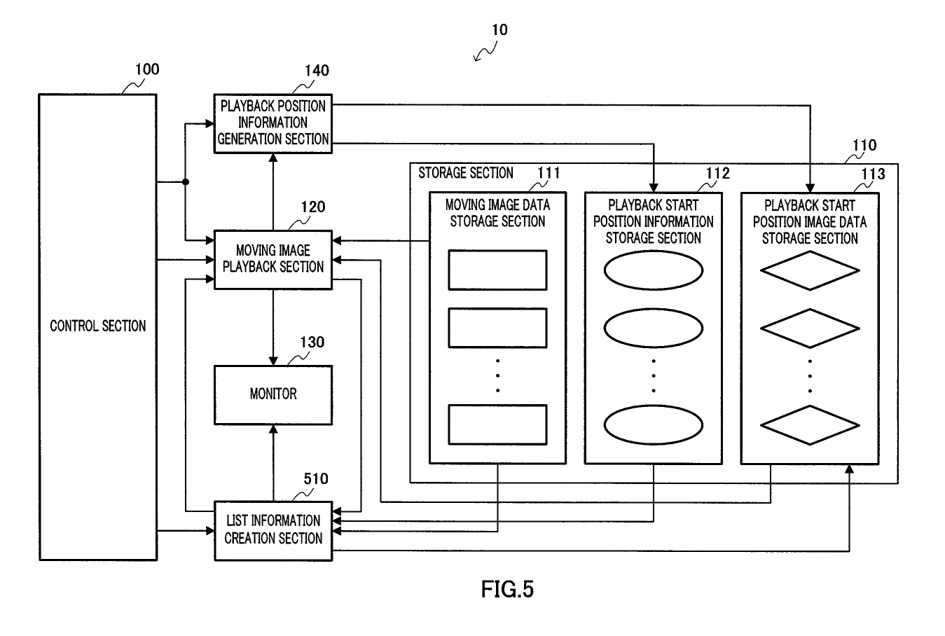

FIG. 5 is a block diagram showing the configuration of moving image playback apparatus 10 according to Embodiment 2 of the present invention.

Compared with moving image playback apparatus 1 according to embodiment shown in FIG. 1, moving image playback apparatus 10 shown in FIG. 5 has list information creation section 510 instead of list information creation section 150. Parts in FIG. 5 that are identical in configuration to parts in FIG. 1 are assigned the same reference codes as in FIG. 1, and descriptions thereof are omitted here.

Control section 100 performs overall control of moving image playback apparatus 10. Also, control section 100 generates a control signal for starting or interrupting moving image playback apparatus 10 playback operation based on a directive from an operation section (not shown), and outputs this control signal to moving image playback section 120, playback position information generation section 140, and list information creation section 510. Furthermore, control section 100 generates an image selection signal specifying an image when a list is created by list information creation section 510, and outputs this image selection signal to moving image playback section 120.

Moving image playback section 120 performs decoding processing of playback start position image data acquired from playback start position image data storage section 113, and outputs this data to list information creation section 510. Other processing by moving image playback section 120 in FIG. 5 is identical to processing by moving image playback section 120 in FIG. 1, and therefore a description thereof is omitted here.

List information creation section 510 determines whether or not playback start position information has been stored in playback start position information storage section 112 within storage section 110. If list information creation section 510 determines that playback start position information has been stored, list information creation section 510 gives a directive for output of playback start position image data stored in playback start position image data storage section 113 within storage section 110 to moving image playback section 120, and acquires playback start position image data that has undergone decoding processing from moving image playback section 120. On the other hand, if list information creation section 510 determines that playback start position information has not been stored, list information creation section 510 issues a request to moving image playback section 120 for first-frame display image output, and acquires a display image. Furthermore, list information creation section 510 generates a thumbnail image based on playback start position information acquired from playback start position information storage section 112 within storage section 110 and playback start position image data that has undergone decoding processing acquired from moving image playback section 120 or a display image acquired from moving image playback section 120, and outputs the generated thumbnail image to monitor 130.

Also, list information creation section 510 reads moving image data stored in moving image data storage section 111 and performs determination of whether or not the data is content for which playback is possible. Then list information creation section 510 generates list information for content for which playback is possible by means of images. On the other hand, if list information creation section 510 determines that playback of all content is impossible, list information creation section 510 generates list information that does not include any images. For example, when generating list information, list information creation section 510 determines whether or not content can be played back by determining whether or not content playback is restricted by copyright, whether or not the present time is within a period in which content playback is possible, or whether or not important header information essential for playback can be read correctly. At this time, list information creation section 510 determines that content playback is possible if content playback is not restricted by copyright, if the present time is within a period in which content playback is possible, or if important header information essential for playback can be read correctly.

Monitor 130 displays a display image played back by moving image playback section 120. Also, monitor 130 displays a thumbnail image input from list information creation section 510.

Thus, according to this embodiment, in addition to obtaining the effects of above-described Embodiment 1, list display is not performed for an image of content that cannot be played back, making it possible to prevent a situation in which content displayed in a list is selected but that selected content cannot be played back.

### INDUSTRIAL APPLICABILITY

A moving image playback apparatus and moving image playback method according to the present invention are particularly suitable for displaying a list of content.

1. A moving image playback apparatus comprising:
a moving image playback section that decodes encoded moving image data and plays back a moving image;
a storage section that stores image data of an image displayed by the playback within a predetermined time period including a time at which interruption occurred when the playback is interrupted;
a list generation section that generates a list of images of each content for which playback is possible of the image data stored in the storage section; and
a display section that displays the list generated by the list generation section.

2. The moving image playback apparatus according to claim 1, wherein the storage section stores image data of an image being displayed on the display section at the time of the interruption.

3. The moving image playback apparatus according to claim 1, further comprising a playback position information generation section that encodes the image data by means of an intra encoding method,
wherein the storage section stores the image data encoded by means of an intra encoding method.

4. The moving image playback apparatus according to claim 3, wherein the playback position information generation section encodes the image data by means of an intra encoding method that is an encoding method identical to an encoding method of the moving image data.

5. The moving image playback apparatus according to claim 1, further comprising a playback position information generation section that encodes image data of an image for which a size of an image displayed by the playback within the predetermined time period has been changed to a size of an image when displayed in the list,
wherein the storage section stores the image data encoded by the playback position information generation section.

6. The moving image playback apparatus according to claim 1, wherein the storage section stores image data encoded by means of an intra-screen predictive encoding method present between image data encoded by means of an intra encoding method or image data encoded by means of a bidirectional predictive encoding method.

7. The moving image playback apparatus according to claim 1, wherein the list generation section generates list information that does not include an image when playback of all content is impossible.

8. A moving image playback method comprising:
a step of decoding encoded moving image data and playing back a moving image;
a step of storing image data of an image displayed by the playback within a predetermined time period including a time at which interruption occurred when the playback is interrupted;
a step of generating a list of images for which playback is possible of each content of the image data that has been stored; and
a step of displaying the moving image that has been played back and also displaying the list.
